(19) United States
(12) Patent Application Publication
(10) Pub. No.: US 2022/0027126 A1
(43) Pub. Date: Jan. 27, 2022

(54) DATA NORMALIZATION PROCESSING METHOD, STORAGE MEDIUM AND COMPUTER EQUIPMENT

(71) Applicant: Shanghai Cambricon Information Technology Co., Ltd., Pudong New Area (CN)

(72) Inventors: Ziheng CAO, Pudong New Area (CN); Jinhong ZHOU, Pudong New Area (CN); Qihuan ZHANG, Pudong New Area (CN)

(21) Appl. No.: 17/361,828

(22) Filed: Jun. 29, 2021

(30) Foreign Application Priority Data
Jul. 22, 2020 (CN) 202010709417.0

(51) Int. Cl. G06F 5/01; G06F 7/552

(52) U.S. Cl. CPC G06F 5/01; G06N 3/04; G06F 7/552

(57) ABSTRACT

The present disclosure provides a data normalization processing method, a storage medium, and a computer device. According to the technical solution provided in the present disclosure, by adopting the method of data scaling and operator splicing, the input data in the deep learning neural network is normalized, which reduces the complexity of the normalization operation in the existing deep learning neural network, effectively prevents the data overflow in the process of data processing, and improves the operation speed of the deep learning neural network.

### TECHNICAL FIELD

The present disclosure relates to the field of artificial intelligence, and particularly relates to a data normalization processing method, a data normalization processing device, a computer-readable storage medium, and a computer device.

### BACKGROUND

In order to accelerate the convergence speed of the deep learning neural network model and improve the accuracy of the model, the normalization layer is widely used in the training process of the deep learning neural network. In order to ensure the accuracy of the model, the normalization layer will also be retained in the process of forward propagation, i.e., inference. In order to improve the performance of the deep learning neural network model, in the process of forward propagation, it is often necessary to normalize the input data, in other words, the floating-point number is converted to integer.

In actual situations, there will often be a large amount of input data. At this time, when computing with the L2 Normalization operator, the sum of squares of the input data may easily exceed the expression range of the integer data type or even the floating-point data type, in other words, the phenomenon of data overflow occurs, which will result in abnormal model operation.

Therefore, during the forward propagation process of the deep learning neural network model, it is necessary to prevent the data in the normalization layer from overflowing.

### SUMMARY

In order to solve the above-mentioned technical problems, the present disclosure provides a data normalization processing method, which is suitable for the normalization layer in the deep learning neural network, and the data normalization processing method includes:

computing a scaling factor of input data according to a maximum value of quantized data type of the input data and a maximum value of input data; and

computing a first product of the scaling factor and the input data, and computing a normalization result of the input data in the normalization layer according to the first product.

The present disclosure also provides a data normalization processing device applied to the normalization layer in the deep learning neural network, and the data normalization processing device includes:

a computation unit of scaling factor configured to compute a scaling factor of the input data according to the maximum value of the quantized input data and the maximum value of the input data; and

a normalization computation unit configured to compute a first product of the scaling factor and the input data, and compute a normalization result of the input data in the normalization layer according to the first product.

The present disclosure further provides a computer-readable storage medium on which a computer program is stored, where when the computer program is executed by a processor, the data normalization processing method is implemented to perform normalization processing on the data.

The present disclosure further provides a computer device, including a memory, a processor, and a computer program stored in the memory and run on the processor. The data normalization processing method is implemented when the processor executes the computer program.

The beneficial effects of the present disclosure are as follows.

According to the technical solution provided in the present disclosure, the quantized maximum value of the input data and the maximum value of the input data are introduced as the basis for computing the scaling factor, and the computed scaling factor is used to scale the input data, which can effectively prevent data overflow during data processing, improve the computation accuracy of input data normalization (quantization), and improve the performance of data normalization processing.

According to the present disclosure, data scaling operation is performed in the normalization layer or inside the operator, which simplifies the computation process of normalization operation, reduces the amount of computation in the computation process, and makes it simpler than the existing normalization operation, and users do not need additional operations.

In addition, according to the present disclosure, when performing normalization operations, especially when performing normalization operations on AI (Artificial intelligence) chips, the basic operator splicing method is adopted to complete the function of the L2Normalization operator. Compared with the L2Normalization operator, the operator splicing method provided in the present disclosure has the same computation effect, while also reducing the complexity of the normalization operation on the AI chips, and at the same time, the operator splicing method also avoids the extra workload caused by the development of new operators, which helps to improve the performance of the overall AI chips.

### BRIEF DESCRIPTION OF THE DRAWINGS

The above-mentioned and/or additional advantages of the present disclosure will become obvious and easy to understand in the description of the embodiments in conjunction with the following drawings.

FIG. 1 shows a schematic diagram of a processor of a data normalization processing method according to an embodiment of the present disclosure.

FIG. 2 shows a schematic flowchart of a data normalization processing method according to an embodiment of the present disclosure.

FIG. 3 shows a schematic flowchart of an operator splicing process according to an embodiment of the present disclosure.

FIG. 4 shows a schematic block diagram of a data normalization processing device according to an embodiment of the present disclosure.

### DETAILED DESCRIPTION

Technical solutions in the embodiments of the present disclosure will be described clearly and completely hereinafter with reference to the accompanied drawings in the embodiments of the present disclosure. Apparently, the described embodiments are merely some rather than all embodiments of the present disclosure. All other embodiments obtained by those of ordinary skill in the art based on the embodiments of the present disclosure without creative efforts shall fall within the protection scope of the present disclosure.

It should also be understood that the terms used in the specification of the present disclosure are merely intended to describe specific examples rather than to limit the present disclosure. As used in the specification and claims of the present disclosure, singular forms of “a”, “one”, and “the” are intended to include plural forms unless the context clearly indicates other circumstances. It should be further understood that the term “and/or” used in the specification and claims of the present disclosure refers to any combination and all possible combinations of one or more listed relevant items, and the combinations are included.

As used in the specification and claims of the present disclosure, the term “if” may be interpreted as “when”, “once”, “in response to determining”, or “in response to detecting” according to the context. Similarly, phrases such as “if determining” or “if detecting [the described conditions or events]” may be interpreted as “once determining”, “in response to determining”, “once detecting [the described conditions or events]”, or “in response to detecting [the described conditions or events]”.

The data processing method provided in the embodiments of the present disclosure may be applied to a first processing device such as a processor, where the processor may be a Central Processing Unit (CPU) or an artificial intelligence processor (IPU) for performing artificial intelligence operations, where the artificial intelligence operations may include machine learning operations, brain-like operations, and the like, where the machine learning operations may include neural network operations, k-means operations, support vector machine operations, and the like. The artificial intelligence processor may include one or more of, for example, a GPU (Graphics Processing Unit), an NPU (Neural-Network Processing Unit), a DSP (Digital Signal Process) unit, and an FPGA (Field-Programmable Gate Array) chip. The artificial intelligence processor may include a plurality of operation units, and the plurality of operation units may perform operations in parallel. The present disclosure does not limit the specific types of the processors.

In some embodiments, the processors mentioned in the present disclosure may include a plurality of processing units, and each processing unit may independently execute various assigned tasks, such as scaling factor computation task, data normalization computation task, etc. The present disclosure does not limit the processing unit and the tasks executed by the processing unit.

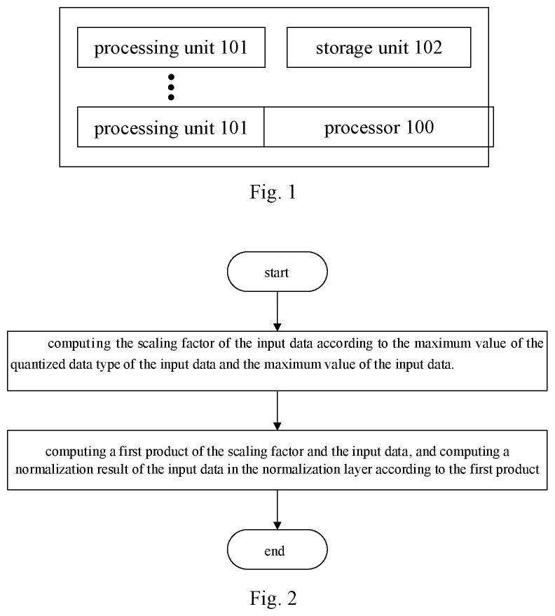

FIG. 1 shows a schematic diagram of a processor of a data normalization processing method according to an embodiment of the present disclosure. The processor is applied to a normalization operation of a normalization layer in a deep learning neural network. As shown in FIG. 1, the processor 100 includes a plurality of processing units 101 and a storage unit 102. The plurality of processing units 101 are used to execute instruction sequences; the storage unit 102 is used to store data, and includes random access memory and a register file. The plurality of processing units 101 in the processor 100 may share part of the storage space, such as part of the RAM storage space and the register file, and can also have their own storage space at the same time. The processing units 101 in the processor 100 execute the assigned tasks, which may reduce the amount of computation in the normalization operation process while preventing data overflow, and improve the overall performance of the device.

When the processor 100 executes the normalization operation, the normalization operation method is shown in FIG. 2. The processing unit 101 computes the scaling factor of the input data according to the maximum value of the quantized (normalized) data type of the input data and the maximum value of the input data.

Optionally, the input data may be one-dimensional, two-dimensional, or multi-dimensional, which is not limited in the present disclosure.

Optionally, the input data is floating point data, which can be 32-bit floating point data, 16-bit floating point data, 64-bit floating point data, etc. The quantized data is fixed point data, including 8-bit fixed point data, 16-bit fixed point data, etc., which is not limited in the present disclosure. The maximum value of the quantized data type refers to the maximum within the value range represented by the data type. For example, the range represented by 8-bit fixed-point data is [−128,127], and the maximum value of the quantized data type is 127.

According to the present disclosure, specific methods for quantizing input data include:

according to a quantization type, successively computing an actual value represented by each quantized data, and then generating an initial quantization data, where the computation formula of the actual value is as follows:

value≈i*2^{position/scale},

for the above-mentioned value, value is the actual value, position is the statistical parameter, scale is the fine tuning parameter, the value range is [1,2); and

fine-tuning the initial quantization data according to the fine tuning parameter, and then generating the quantized data.

The following example is used to illustrate the data quantization process.

When a floating point tensor (n-dimensional array) is represented by int8, the tensor consists of three parts, including:
1. 8-bit signed integer tensor (int8) tensor,
2. int position,
3. floating point scale.

Therefore, the computation formula of the actual floating point value represented by each data among int8 tensor is as follows:

value≈i*2^{position/scale},

for the formula, i is int8-type data, and position is obtained through statistics. The statistical method is as follows:
1. obtaining the maximum max and minimum min in the tensor,
2. from −16, adding 1 to the position each time until int8-type data covers both the maximum and minimum values,
3. computing scale after the position is obtained, where scale is a fine-tuning of the coverage range of int8-type data, and the value range of scale is [1,2).

In some embodiments, the computation formula of the scaling factor is:

$$β = \sqrt{\frac{Max}{n}} \text{/} {x}_{max} ,$$

for the formula, β is the scaling factor, Max is the maximum value of the quantized data type of the input data, xₘₐₓ is the maximum value of the input data, n is the total number of the input data, and n is a positive integer greater than 1.

In some embodiments, the computation formula of the scaling factor may be Max/xₘₐₓ.

The scaling factor in this application is determined according to the maximum value of the quantized data type and the maximum value of the input data. The specific computation formula of the scaling factor is not limited in the present disclosure.

By setting the scaling factor and introducing the maximum value of the quantized data type, the computation accuracy of scaling factor can be improved, the computation amount of scaling factor can be reduced, and the data overflow prevention effect can be improved.

The processing units 101 compute the first product of the scaling factor and the input data, and then use the first product to compute the normalization result of the L2normalization operator in the normalization layer.

Specifically, in the normalization layer of the deep learning neural network model, the L2 Normalization operator is usually used to normalize the input data so as to improve the performance of the deep learning neural network model.

Before performing the normalization operation, the processing units 101 use the computed scaling factor to scale the input data in equal proportion, in other words, the scaling factor is multiplied with the input data one by one. And then, the product is brought to the L2 Normalization operator for normalization operation. At this time, the computation formula for the normalization of the L2 Normalization operator is:

$${y}_{i} = \frac{β {x}_{i}}{\sqrt{{\sum }_{i = 1}^{n} {( β {x}_{i} )}^{2}}} ,$$

for the formula, xᵢ is the i-th data in the input data, i=1, 2, . . . , n, n is the total number of input data, and yᵢ is the normalized result corresponding to the input data xᵢ.

It can be seen from the above formula that when normalization is performed, the numerator and denominator are simultaneously scaled by the same multiple, so the corresponding normalization result remains unchanged. However, by scaling the numerator and denominator, data overflow can be effectively prevented and the computation accuracy in the normalization process can be improved.

According to the above-mentioned computation formula of the L2Normalization operator, during the normalization process, the input data needs to be squared first, then the cumulative sum is computed, and the square root of the cumulative sum is computed. After the square root is obtained, the reciprocal of the square root is computed, and then the input data is multiplied with the reciprocal of the square root to complete the normalization operation.

The computation process is very complicated and the amount of computation is large, especially the computation process involves square, accumulative sum and square extraction, therefore, during the normalization operation provided in the present disclosure, the operator splicing replacement is performed to reduce the amount of computation, further enhance the performance of the deep learning neural network model.

The operator splicing method provided in the present disclosure is suitable for the L2Normalization operator to perform the normalization operation of the instance mode, channel mode and other operation modes. The following takes L2Normalization operator to perform instance mode operation as an example for description.

Specifically, when the input data is in the NCHW format, the instance refers to the operation of each batch, or the operation on the input data in N-direction, and the operation mode at this time is taken as an example mode.

The channel mode refers to the channel in which the input data is RGB picture, and the operation refers to an operation performed on the input data in NCHW format in C-direction, and the operation mode at this time is taken as a channel mode.

When the input data is in NCHW format, the L2Normalization operator performs the instance mode operation at this time. Taking data of a picture processing as an example, according to the set dimensions, the processing sequence is generally: N direction->H direction->W direction->C direction, where N is usually called instance or batch, H is usually called the height of the picture, W is the width of the picture, and C is the channel of the picture.

Those skilled in the art can understand that when the input data is in the NCHW format, operations may be performed on 1-dimensional, 2-dimensional, 3-dimensional, and 4-dimensional data, in other words, when the data in any one of the four directions is greater than 1, and the data in the remaining three directions is equal to 1, the operation may be performed on the 1-dimensional data; when the data in any two directions is greater than 1, and the data in the remaining two directions is equal to 1, the operation may be performed on the 2-dimensional data; when the data in any three directions is greater than 1, and the data in the remaining direction is equal to 1, the operation may be performed on the 3-dimensional data; and when the data in 4 directions are all greater than 1, the operation may be performed on the 4-dimensional data.

The present disclosure only takes the N-direction data as an example, in other words, the operator splicing method is described with 1-dimensional data.

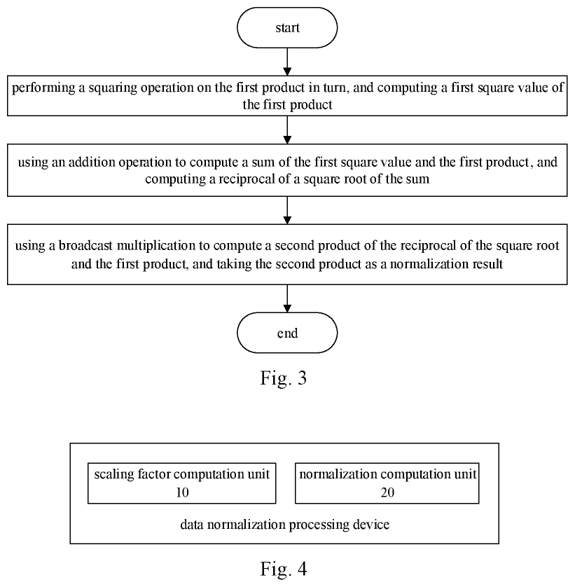

As shown in FIG. 3, the processing units 101 adopt the method of operator splicing, and the specific process of computing the normalization result of the L2Normalization operator in the normalization layer of the input data is as follows:

after normalizing the data in the N direction, taking the first product βxᵢ as the data A1, and performing the squaring (multiplication) operation (NCHW)×(NCHW) to compute the first square value of the data A1 to obtain the data A2;

performing a summation operation on data A1 and data A2 in the N direction, at this time, the data dimension in the N direction becomes 1, and the other dimensions remain unchanged, in other words, NCHW->1 CHW, and then taking the sum of the two as data A3;

extracting the square root of the data A3 and taking the reciprocal, in other words, 1 CHW->1/\sqrt{(1CHW)}, obtaining the square root reciprocal of the data A3, which is taken as A4, where the data A4 is 3-dimensional data, A1 is 4-dimensional data, and the dimension of data A4 is one less than data A1; and performing a multiplication operation of different dimensions on the data A4 and the data A1, i.e., the broadcast multiplication broadcast_mult, to obtain a second product corresponding to the input data, and the second product is taken as the normalization result of the L2Normalization operator.

The broadcast multiplication is explained as follows: the broadcast multiplication is a multiplication between a small matrix and a large matrix, where the “small” and “large” refer to the dimension of the data, relatively speaking, the dimension of the small matrix is smaller than that of the large matrix. The large matrix is divided into at least two sub-matrices according to the dimensions of the small matrix, operations are performed on the at least two sub-matrices and the small matrix respectively, and the obtained products are taken as the sub-matrix products, and the sum of the sub-matrix products is obtained by performing an addition operation, the sum is the final result of the small matrix and the large matrix. In the present disclosure, the reciprocal of the square root is a 3-dimensional matrix, which is a small matrix, and the first product is a 4-dimensional matrix, which is a large matrix. In the present disclosure, the specific method of using the broadcast multiplication to compute the second product includes:

according to the dimension of the reciprocal of the square root, dividing the first product into at least two sub-matrices, where the dimension of the reciprocal of the square root is smaller than the dimension of the first product, and the dimension of the divided sub-matrix is equal to the dimension of the reciprocal of the square root, in other words, the broadcast multiplication is performed on the reciprocal of the square root;

computing products of the reciprocal of the square root and the sub-matrices in turn, and taking the products as the products of the sub-matrices; and

computing the sum of the sub-matrix products by using the addition operation, and taking the sum as the second product.

Specifically, the data A1 is 4-dimensional data, the data format is NCHW; the data A4 is 3-dimensional data, and the data format is CHW. Therefore, when performing the broadcast multiplication between the A1 and A4, first, according to the dimension of the data A4 and the N direction, dividing the data A1 into N 3-dimensional data to obtain N sub-matrices; sequentially multiplying the N sub-matrices with the data A4 to obtain N sub-matrix products; and adding the N sub-matrix products to obtain the sum of the sub-matrix products, completing the broadcast multiplication, and realizing the computation of the second product.

The above computation process can be described as: mult->sumpool->rsqrt->broadcast_mult.

It should be noted that when the input data is in the RGB image format, the L2Normalization operator performs the channel mode operation at this time, in other words, the input data at this time is the channel of the RGB image, which is equivalent to the C direction in the data format NHWC. At this time, the specific process of the processing units 101 replacing the L2Normalization operator by adopting the operator splicing method is the same as the above-mentioned execution example mode operation, which can be described as: mult->sumpool->rsqrt->broadcast_mult.

According to the above-mentioned operator splicing operation, the basic operator splicing is adopted to avoid the squaring, cumulative summation, and square extraction operation in the computation process of the L2Normalization operator, making the operator splicing method in the present disclosure has the same computation effect as the conventional L2Normalization operator. In addition, adopting the operator splicing method also reduces the complexity of data normalization, simplifies the normalization operation of the Normalization layer in the deep learning neural network model, and avoids the additional workload caused by the development of new operators.

On the basis of the above embodiments, as shown in FIG. 4, the present disclosure also provides a data normalization processing device, which includes a scaling factor computation unit 10 and a normalization computation unit 20. The scaling factor computation unit 10 and the normalization computation unit 20 perform the normalization operation of the normalization layer in the deep learning neural network, which reduces the amount of computation during the normalization operation while preventing data overflow, and improves the overall performance of the device.

The scaling factor computation unit 10 is configured to compute the scaling factor of the input data according to the maximum value of the quantized (normalized) data type of the input data and the maximum value of the input data.

Optionally, the input data may be one-dimensional, two-dimensional, or multi-dimensional, which is not limited in the present disclosure.

Optionally, the input data is floating point data, which can be 32-bit floating point data, 16-bit floating point data, 64-bit floating point data, etc. The quantized data is fixed point data, including 8-bit fixed point data, 16-bit fixed point data, etc., which is not limited in the present disclosure. The maximum value of the quantized data type refers to the maximum within the value range represented by the data type. For example, the range represented by 8-bit fixed-point data is [−128,127], and the maximum value of the quantized data type is 127.

In some embodiments, the computation formula of the scaling factor is:

$$β = \sqrt{\frac{Max}{n}} \text{/} {x}_{max} ,$$

for the formula, β is the scaling factor, Max is the maximum value of the quantized data type of the input data, xₘₐₓ is the maximum value of the input data, n is the total number of the input data, and n is a positive integer greater than 1.

In some embodiments, the computation formula of the scaling factor may be Max/xₘₐₓ.

The scaling factor in this application is determined according to the maximum value of the quantized data type and the maximum value of the input data. The specific computation formula of the scaling factor is not limited in the present disclosure.

By setting the scaling factor and introducing the maximum value of the quantized data type, the computation accuracy of scaling factor can be improved, the computation amount of scaling factor can be reduced, and the data overflow prevention effect can be improved.

The normalization computation unit 20 is configured to compute the first product of the scaling factor and the input data, and then use the first product to compute the normalization result of the L2normalization operator in the normalization layer.

Specifically, in the normalization layer of the deep learning neural network model, the L2 Normalization operator is usually used to normalize the input data so as to improve the performance of the deep learning neural network model.

Before performing the normalization operation, the normalization computation unit 20 uses the computed scaling factor to scale the input data in equal proportion, in other words, the scaling factor is multiplied with the input data one by one. And then, the product is brought to the L2 Normalization operator for normalization operation. At this time, the computation formula for the normalization of the L2 Normalization operator is:

$${y}_{i} = \frac{β {x}_{i}}{\sqrt{{\sum }_{i = 1}^{n} {( β {x}_{i} )}^{2}}} ,$$

for the formula, xᵢ is the i-th data in the input data, i=1, 2, . . . , n, n is the total number of input data, and yᵢ is the normalized result corresponding to the input data xᵢ.

It can be seen from the above formula that when normalization is performed, the numerator and denominator are simultaneously scaled by the same multiple, so the corresponding normalization result remains unchanged. However, by scaling the numerator and denominator, data overflow can be effectively prevented and the computation accuracy in the normalization process can be improved.

According to the above-mentioned computation formula of the L2Normalization operator, during the normalization process, the input data needs to be squared first, then the cumulative sum is computed, and the square root of the cumulative sum is computed. After the square root is obtained, the reciprocal of the square root is computed, and then the input data is multiplied with the reciprocal of the square root to complete the normalization operation.

The computation process is very complicated and the amount of computation is large, especially the computation process involves square, accumulative sum and square extraction, therefore, during the normalization operation provided in the present disclosure, the operator splicing replacement is performed to reduce the amount of computation, further enhance the performance of the deep learning neural network model.

The operator splicing method provided in the present disclosure is suitable for the L2Normalization operator to perform the normalization operation of the instance mode, channel mode and other operation modes. The following takes L2Normalization operator to perform instance mode operation as an example for description.

Specifically, when the input data is in the NCHW format, the instance refers to the operation of each batch, or the operation on the input data in N-direction, and the operation mode at this time is taken as an example mode.

The channel mode refers to the channel in which the input data is RGB picture, and the operation refers to an operation performed on the input data in NCHW format in C-direction, and the operation mode at this time is taken as a channel mode.

When the input data is in NCHW format, the L2Normalization operator performs the instance mode operation at this time. Taking data of a picture processing as an example, according to the set dimensions, the processing sequence is generally: N direction->H direction->W direction->C direction, where N is usually called instance or batch, H is usually called the height of the picture, W is the width of the picture, and C is the channel of the picture.

Those skilled in the art can understand that when the input data is in the NCHW format, operations may be performed on 1-dimensional, 2-dimensional, 3-dimensional, and 4-dimensional data, in other words, when the data in any one of the four directions is greater than 1, and the data in the remaining three directions is equal to 1, the operation may be performed on the 1-dimensional data; when the data in any two directions is greater than 1, and the data in the remaining two directions is equal to 1, the operation may be performed on the 2-dimensional data; when the data in any three directions is greater than 1, and the data in the remaining direction is equal to 1, the operation may be performed on the 3-dimensional data; and when the data in 4 directions are all greater than 1, the operation may be performed on the 4-dimensional data.

The present disclosure only takes the N-direction data as an example, in other words, the operator splicing method is described with 1-dimensional data.

The normalization computation unit 20 adopts the method of operator splicing, and the specific process of computing the normalization result of the L2Normalization operator in the normalization layer of the input data is as follows:

after normalizing the data in the N direction, taking the first product βxᵢ as the data A1, and performing the squaring (multiplication) operation (NCHW)×(NCHW) to compute the first square value of the data A1 to obtain the data A2;

performing a summation operation on data A1 and data A2 in the N direction, at this time, the data dimension in the N direction becomes 1, and the other dimensions remain unchanged, in other words, NCHW->1 CHW, and then taking the sum of the two as data A3;

extracting the square root of the data A3 and taking the reciprocal, in other words, 1 CHW->1/\sqrt{(1CHW)}, obtaining the square root reciprocal of the data A3, which is taken as A4, where the data A4 is 3-dimensional data, A1 is 4-dimensional data, and the dimension of data A4 is one less than data A1; and performing a multiplication operation of different dimensions on the data A4 and the data A1, i.e., the broadcast multiplication broadcast_mult, to obtain a second product corresponding to the input data, and the second product is taken as the normalization result of the L2Normalization operator.

The broadcast multiplication is explained as follows: the broadcast multiplication is a multiplication between a small matrix and a large matrix, where the “small” and “large” refer to the dimension of the data, relatively speaking, the dimension of the small matrix is smaller than that of the large matrix. The large matrix is divided into at least two sub-matrices according to the dimensions of the small matrix, operations are performed on the at least two sub-matrices and the small matrix respectively, and the obtained products are taken as the sub-matrix products, and the sum of the sub-matrix products is obtained by performing an addition operation, the sum is the final result of the small matrix and the large matrix. In the present disclosure, the reciprocal of the square root is a 3-dimensional matrix, which is a small matrix, and the first product is a 4-dimensional matrix, which is a large matrix.

In the present disclosure, the specific method of using broadcast multiplication to compute the second product includes:

according to the dimension of the reciprocal of the square root, dividing the first product into at least two sub-matrices, where the dimension of the reciprocal of the square root is smaller than the dimension of the first product, and the dimension of the divided sub-matrix is equal to the dimension of the reciprocal of the square root, in other words, the broadcast multiplication is performed on the reciprocal of the square root;

computing the product of the reciprocal of the square root and the sub-matrix in turn, and taking the products as the sub-matrix products; and

computing the sum of the sub-matrix products by using the addition operation, and taking the sum as the second product.

Specifically, the data A1 is 4-dimensional data, the data format is NCHW; the data A4 is 3-dimensional data, and the data format is CHW. Therefore, when performing the broadcast multiplication between the A1 and A4, first, according to the dimension of the data A4 and the N direction, dividing the data A1 into N 3-dimensional data to obtain N sub-matrices; sequentially multiplying the N sub-matrices with the data A4 to obtain N sub-matrix products; and adding the N sub-matrix products to obtain the sum of the sub-matrix products, completing the broadcast multiplication, and realizing the computation of the second product.

The above computation process can be described as: mult->sumpool->rsqrt->broadcast_mult.

It should be noted that when the input data is in the RGB image format, the L2Normalization operator performs the channel mode operation at this time, in other words, the input data at this time is the channel of the RGB image, which is equivalent to the C direction in the data format NHWC. At this time, the specific process of the processing units 101 replacing the L2Normalization operator by adopting the operator splicing method is the same as the above-mentioned execution example mode operation, which can be described as: mult->sumpool->rsqrt->broadcast_mult.

In some embodiments, the data normalization processing method provided in the embodiments of the present disclosure is stored in a computer-readable storage medium in the form of a computer program. When the computer-readable storage medium is run by a computer device, a plurality of processing units in the computer device can independently execute various assigned tasks, such as scaling factor computation task, operator splicing task, etc. The present disclosure does not limit the tasks executed by the processing unit. The above-mentioned processing unit may be any appropriate hardware processor, such as CPU (Central Processing Unit), GPU (Graphic Processing Unit), FPGA (Field Programmable Gate Array), DSP (Digital Signal Processing), ASIC (Application Specific Integrated Circuits), etc., or an artificial intelligence processor (IPU) for performing artificial intelligence operations.

It should be noted that, for the sake of simple description, the above method embodiments are all described as a series of action combinations. However, those skilled in the art should be aware that the present disclosure is not limited by the described action order, because according to the present disclosure, certain steps may be executed in another order or executed simultaneously. Those skilled in the art should also be aware that the embodiments described in the specification are alternative embodiments and that the actions and modules involved are not necessary in the present disclosure.

It should be further noted that although the steps in FIG. 2 and FIG. 3 are shown in sequence as indicated by the arrows, these steps are not necessarily executed in the order indicated by the arrows. Unless specifically stated in the present disclosure, the execution of these steps is not strictly limited in order, and these steps may be executed in other orders. In addition, at least part of the steps in the FIG. 2 may include a plurality of sub-steps or stages. These sub-steps or stages are not necessarily executed at the same time, but may be executed at different times. The execution of these sub-steps or stages is not necessarily performed sequentially, but may be performed alternately with other steps or at least a part of the sub-steps or stages of other steps.

It should be understood that the apparatus embodiment described above is only schematic, and the device provided in the present disclosure may be implemented in other manners. For example, division of the units/modules is only logical function division and another division manner may be adopted during practical implementation. For example, a plurality of units or components may be combined or integrated into another system or some characteristics may be neglected or not performed.

In addition, unless otherwise specified, each functional unit/module in the embodiments of the disclosure may be integrated into a unit/module, each unit/module may also physically exist independently, and two or more units/modules may also be integrated into one unit/module. The integrated unit/module may be implemented in the form of hardware or a software functional unit/module.

If the integrated unit/module is implemented in the form of hardware, the hardware may be a digital circuit, an analogue circuit, and the like. The physical implementation of hardware may include, but is not limited to, a transistor, a memristor, and the like. Unless otherwise specified, the scaling factor computation unit and the normalization computation unit may be any appropriate hardware processor, such as CPU, GPU, FPGA, DSP, ASIC, and the like.

If the integrated unit/module is implemented in the form of hardware, the hardware may be a digital circuit, an analogue circuit, and the like. The physical implementation of hardware may include, but is not limited to, a transistor, a memristor, and the like. Unless otherwise specified, the artificial intelligence processor may be any appropriate hardware processor, such as CPU, GPU, FPGA, DSP, ASIC, and the like. Unless otherwise specified, the storage unit may be any proper magnetic storage medium or magneto-optic storage medium, for example, an RRAM (Resistive Random Access Memory), a DRAM (Dynamic Random Access Memory), an SRAM (Static Random-Access Memory), an EDRAM (Enhanced Dynamic Random Access Memory), an HBM (High-Bandwidth Memory), an HMC (Hybrid Memory Cube), and the like.

In the above-mentioned embodiments, the description of each embodiment has its own focus. For parts that are not described in detail in an embodiment, please refer to related descriptions of other embodiments. The technical features of the above-mentioned embodiments may be combined arbitrarily. In order to make the description concise, not all possible combinations of the various technical features in the above-mentioned embodiments are described. However, as long as there is no contradiction in the combinations of these technical features, they should be regarded as the scope of this specification.

The foregoing may be better understood according to the following articles:

A1. A data normalization processing method suitable for a normalization layer in a deep learning neural network, wherein the data normalization processing method includes:

computing a scaling factor of input data according to a maximum value of quantized data type of the input data and a maximum value of input data, and

computing a first product of the scaling factor and the input data, and computing a normalization result of the input data in the normalization layer according to the first product.

A2. The data normalization processing method of A1, wherein a computation formula of the scaling factor is:

$$β = \sqrt{\frac{Max}{n}} \text{/} {x}_{max} ,$$

for the formula, β is the scaling factor, Max is the maximum value of the quantized data type of the input data, xₘₐₓ is the maximum value of the input data, n is a total number of the input data.

A3. The data normalization processing method of A2, wherein the computing the normalization result of the input data in the normalization layer in a step 2 includes:

performing a squaring operation on the first product in turn, and computing a first square value of the first product,

using an addition operation to compute a sum of the first square value and the first product, and computing a reciprocal of a square root of the sum, and

using a broadcast multiplication to compute a second product of the reciprocal of the square root and the first product, and taking the second product as a normalization result of an L2Normalization operator.

A4. The data normalization processing method of A3, wherein the using the broadcast multiplication to compute the second product of the reciprocal of the square root and the first product includes:

according to the dimension of the reciprocal of the square root, dividing the first product into at least two sub-matrices, where the dimension of the reciprocal of the square root is smaller than the dimension of the first product,

computing products of the reciprocal of the square root and the sub-matrices in turn, and taking the products as products of the sub-matrices, and

computing a sum of the products of the sub-matrices by using the addition operation, and taking the sum as the second product.

A5. The data normalization processing method of A1 or A3, wherein the normalization result is a normalization result of the L2Normalization operator.

A6. The data normalization processing method of A5, wherein operation modes of the L2Normalization operator include an instance mode and a channel mode.

A7. The data normalization processing method of A1, wherein the quantizing the input data includes:

according to a quantization type, successively computing an actual value represented by each quantized data, and then generating an initial quantization data, where a computation formula of the actual value is as follows:

value i*2^{position/scale}, for the above-mentioned value, value is the actual value, position is a statistical parameter, scale is a fine tuning parameter, the value range is [1,2), and

fine-tuning the initial quantization data according to the fine tuning parameter, and then generating the quantized data.

A8. A data normalization processing device, comprising a scaling factor computation unit and a normalization computation unit, wherein

the scaling factor computation unit is configured to compute a scaling factor of input data according to a maximum value of a quantized data type of the input data and a maximum value of the input data, and

the normalization computation unit is configured to compute a first product of the scaling factor and the input data, and then use the first product to compute a normalization result of the input data in a normalization layer.

A9. The data normalization processing device of A8, wherein a computation formula of the scaling factor is:

$$β = \sqrt{\frac{Max}{n}} \text{/} {x}_{max} ,$$

for the formula, β is the scaling factor, Max is the maximum value of the quantized data type of the input data, xₘₐₓ is the maximum value of the input data, n is a total number of the input data.

A10. The data normalization processing device of A9, wherein that the normalization computation unit computes the normalization result of the input data in the normalization layer includes:

perform a squaring operation on the first product in turn, and compute a first square value of the first product,

use an addition operation to compute a sum of the first square value and the first product, and compute a reciprocal of a square root of the sum, and

use a broadcast multiplication to compute a second product of the reciprocal of the square root and the first product, and take the second product as a normalization result.

A11. A computer-readable storage medium on which a computer program is stored, wherein when the computer program is executed by a processor, the data normalization processing method of ant one of A1-A7 is implemented to perform normalization processing on data.

A12. A computer device, comprising a memory, a processor, and a computer program stored in the memory and run on the processor, wherein the data normalization processing method of any one of A1-A7 is implemented when the processor executes the computer program.

The embodiments of the present disclosure are described in detail above, and specific examples are used in the specification to illustrate the principles and implementations of the present disclosure. The descriptions of the above-mentioned embodiments are only used to help understand the methods and core ideas of the present disclosure. At the same time, changes or modifications made by those skilled in the art based on the ideas of the present disclosure, the specific embodiments and the scope of application of the present disclosure, are all within the protection scope of the present disclosure. In summary, the content of this specification should not be construed as a limitation of the present disclosure.

What is claimed:

1. A data normalization processing method suitable for a normalization layer in a deep learning neural network, wherein the data normalization processing method includes:
computing a scaling factor of input data according to a maximum value of quantized data type of the input data and a maximum value of input data, and
computing a first product of the scaling factor and the input data, and computing a normalization result of the input data in the normalization layer according to the first product.

2. The data normalization processing method of claim 1, wherein a computation formula of the scaling factor is:
$$β = \sqrt{\frac{Max}{n}} \text{/} {x}_{max} ,$$
for the formula, β is the scaling factor, Max is the maximum value of the quantized data type of the input data, xₘₐₓ is the maximum value of the input data, n is a total number of the input data.

3. The data normalization processing method of claim 2, wherein the computing the normalization result of the input data in the normalization layer in a step 2 includes:
performing a squaring operation on the first product in turn, and computing a first square value of the first product,
using an addition operation to compute a sum of the first square value and the first product, and computing a reciprocal of a square root of the sum, and
using a broadcast multiplication to compute a second product of the reciprocal of the square root and the first product, and taking the second product as a normalization result of an L2Normalization operator.

4. The data normalization processing method of claim 3, wherein the using the broadcast multiplication to compute the second product of the reciprocal of the square root and the first product includes:
according to the dimension of the reciprocal of the square root, dividing the first product into at least two sub-matrices, where the dimension of the reciprocal of the square root is smaller than the dimension of the first product,
computing products of the reciprocal of the square root and the sub-matrices in turn, and taking the products as products of the sub-matrices, and
computing a sum of the products of the sub-matrices by using the addition operation, and taking the sum as the second product.

5. The data normalization processing method of claim 1, wherein the normalization result is a normalization result of the L2Normalization operator.

6. The data normalization processing method of claim 5, wherein operation modes of the L2Normalization operator include an instance mode and a channel mode.

7. The data normalization processing method of claim 1, wherein the quantizing the input data includes:
according to a quantization type, successively computing an actual value represented by each quantized data, and then generating an initial quantization data, where a computation formula of the actual value is as follows:
value i*2^{position/scale}, for the above-mentioned value, value is the actual value, position is a statistical parameter, scale is a fine tuning parameter, the value range is [1,2), and
fine-tuning the initial quantization data according to the fine tuning parameter, and then generating the quantized data.

8. (canceled)

9. (canceled)
